(19) United States
(12) Patent Application Publication
(10) Pub. No.: US 2021/0351599 A1
(43) Pub. Date: Nov. 11, 2021

(54) Method And System For Maximum Capacity Utilization

(71) Applicants: Franz RÜEGG, Nunningen (CH); Charles RIPPERT, L'Amettla de Mar (ES)

(72) Inventor: Charles Rippert, L?Amettla de Mar (ES)

(21) Appl. No.: 17/278,142

(22) PCT Filed: Sep. 18, 2019
(86) PCT No.: PCT/EP2019/074985

§ 371 Date: Mar. 19, 2021

(30) Foreign Application Priority Data
Sep. 21, 2018 (CH) 01142/18

(51) Int. Cl. H02J 7/00

(52) U.S. Cl. CPC H02J 7/0024; H02J 7/345

(57) ABSTRACT

For the method for utilizing the capacity of mobile capacitors, the mobile capacitors are connected in parallel in order to charge and in series in order to output power. The capacitors are grouped into multiple stages such that, in a first stage, groups consisting of a plurality of interconnected capacitors are formed, in a second stage, a plurality of groups from the first stage are in turn interconnected to form further groups and, in further stages, in each case groups from the respectively previous stage are interconnected to form further groups.

The present invention relates to a method for improving the utilization of the capacity of capacitors according to the preamble of claim 1 and to a device according to claim 3 for carrying out this method.

According to the current prior art, electric cars predominantly obtain the electric power required to move from electrochemically based accumulators. The electric power storage elements are currently those having the greatest energy density that therefore allow for the greatest range based on their weight. Alternative stores that are likewise already used in vehicles are capacitive stores, which, however, currently only reach approximately 10% of the energy density of accumulators and can therefore only be used when recharging is possible at frequent intervals.

The advantage of the high energy density of accumulators is faced with a few weighty disadvantages, such as the long charging time, the comparatively short lifetime, etc. Capacitive stores offer advantages in this regard. However, even though the charging time of capacitive stores is far shorter than that of accumulators, for example, this is still not enough to compensate for the disadvantage of the shorter range.

The object of the invention is therefore to improve the utilization of the capacity of capacitors, in particular mobile ultracapacitors and pseudocapacitors in vehicles, such that the energy density of capacitors that is lower by comparison thereby no longer constitutes a disadvantage.

According to the invention, this is achieved by the characterizing features of claims 1 and 3.

Preferred embodiments are characterized by the features stated in the dependent claims.

In the present description, the term “capacitors” refers to all types of capacitive energy stores having a different technology, in particular those having high capacities in the range of from 1000 F and more, which are, in principle, suitable for driving electric vehicles.

Preferred embodiments of the invention will be described in the following on the basis of the attached drawings, in which

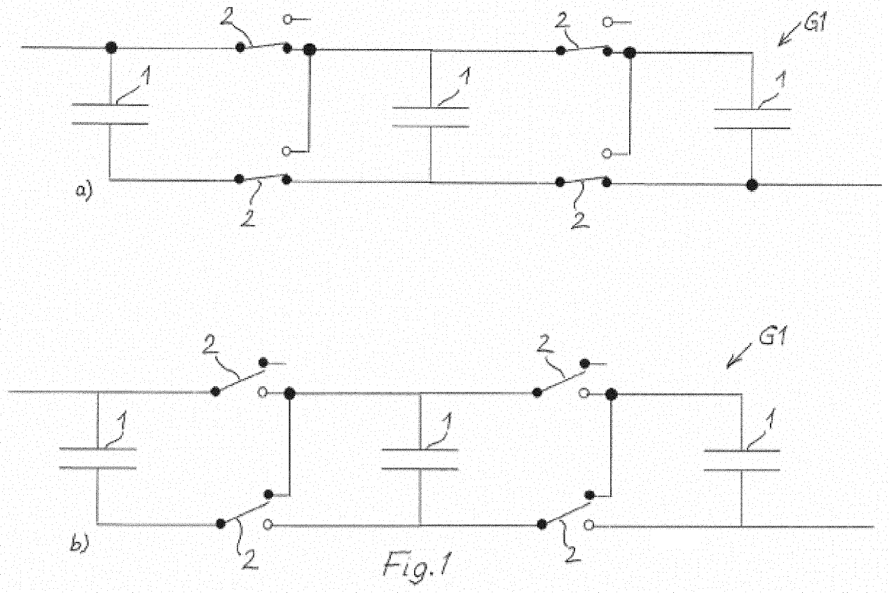

FIG. 1 shows three capacitors connected in series a) or in parallel b) by means of relays,

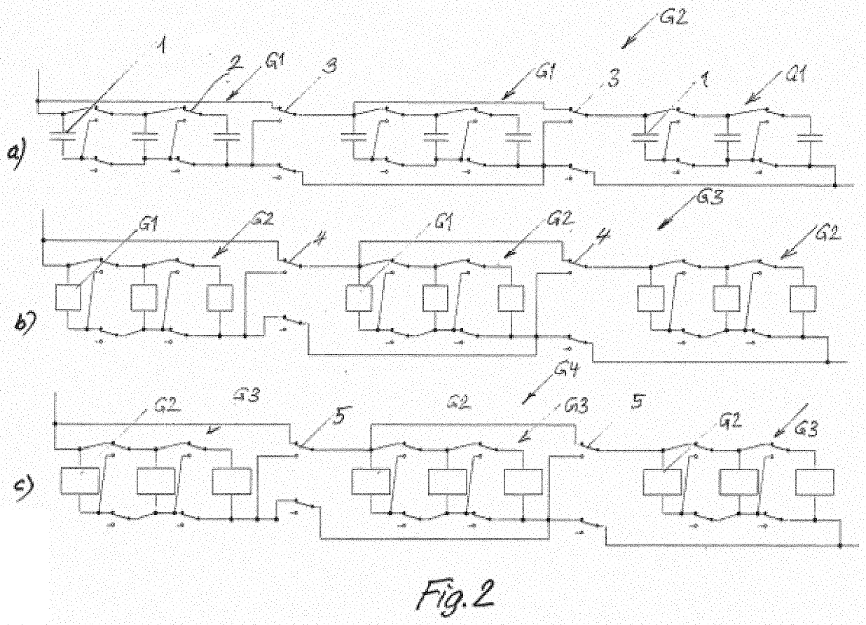

FIG. 2 shows the connection of capacitor groups in a plurality of stages

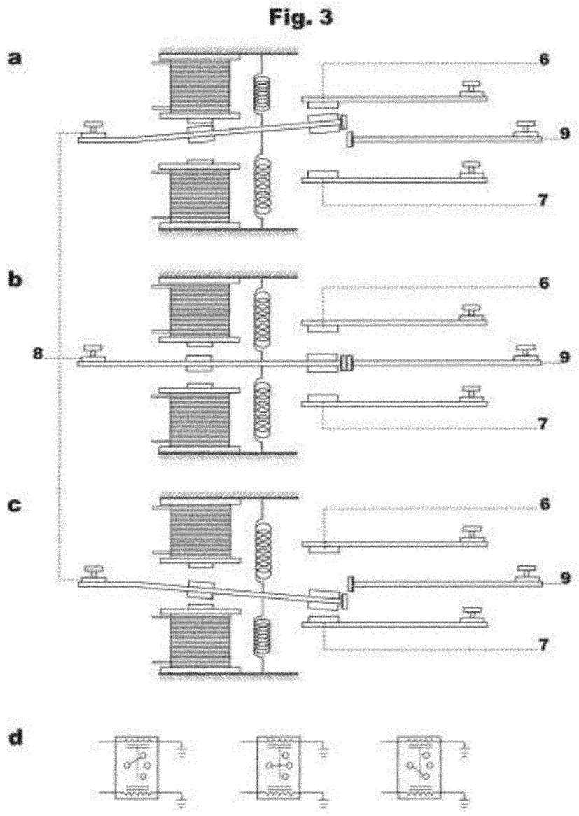

FIG. 3 is a schematic view of a three-pole relay,

FIG. 4 shows three capacitors connected by means of a three-pole relay, and

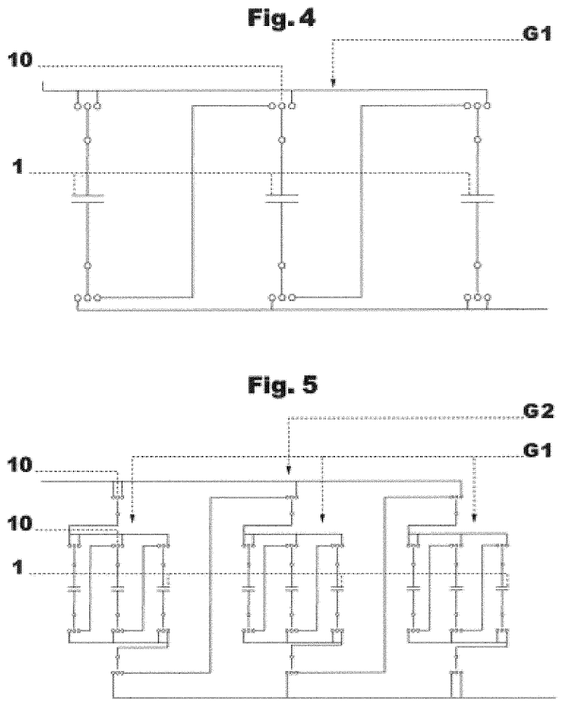

FIG. 5 shows the connection of a plurality of capacitor groups

High-power capacitors, such as ultracapacitors or pseudocapacitors, provide a voltage of typically no more than 2.7 volts, i.e. too low for driving electric vehicles as well as for other applications. In order to achieve higher voltages, a plurality of charged capacitors need to be connected in series to extract the charge. If, however, a plurality of capacitors connected in series are charged, their overall capacity is smaller than the smallest individual capacity. Capacitors connected in series can therefore only hold a fraction of the charge that each of these individual capacitors could hold. As a result, a plurality of capacitors that are required to provide a desired amount of voltage when connected in series have to be connected in parallel for charging purposes in order to be fully charged, i.e. in order to actually use up the available capacity in full.

A connection device is therefore required that connects a plurality of capacitors either in series or in parallel. Such a connection device is a commercially available relay, for example. A group consisting of a plurality of capacitors, which can be connected in series or in parallel by means of a relay, will be referred to as being “interconnected” in the following description. In the same way that a plurality of individual capacitors can be interconnected, it is also possible to interconnect groups of capacitors.

By means of the embodiments described in the following of connecting groups in stages, maximum flexibility is possible in terms of all the parameters required. In a first stage shown in FIG. 1, three capacitors 1 are connected each time to form a group, which is referred to in the following as “group G1 of the first stage” or simply as “group G1”. If they are connected in series in order to extract the charge, as shown in FIG. 1a, they provide a voltage of 8.1 volts. Connected in parallel as in FIG. 1b, they can be fully charged and can all be charged to a voltage of 2.7 volts, for example. Switching from parallel in order to charge to series in order to output power is done by means of four individual conventional relays 2 or a 4-changeover relay.

In a second stage shown in FIG. 2a, three such groups G1 of the first stage are each connected to three capacitors 1 by means of four individual relays 3 or a 4-changeover relay in order to form an additional group G2. This additional group G2 therefore comprises nine capacitors, which, connected in series, provide up to 24.3 volts depending on the state of charge of the capacitors. If some of the capacitors are connected in series and some are connected in parallel, different voltages can be picked off.

FIG. 2b shows a third stage in which three of the groups G2 formed in the second stage are interconnected by four individual relays 4 or a 4-changeover relay in order to form an additional group G3. For the sake of clarity, groups G1 are shown as blocks in this representation. This additional group G3 of the third stage therefore comprises 27 capacitors, which can provide up to 72.9 volts, but also various other voltage values, depending on the connection and state of charge of the capacitors.

FIG. 2c shows a fourth stage in which three of the groups G3 formed in the third stage are interconnected by means of four individual relays or a 4-changeover relay in order to form an additional group G4. Groups G3 are, in turn, shown as blocks. This additional group G4 of the fourth stage comprises 81 capacitors.

In the respective stages, more than just three groups of the underlying stage can also be combined to form groups, which then require a larger number of relays to connect them. According to the formula R=(C-1)*2, R, the number of 1-pole relays, can be calculated using C, the number of capacitors used. This is applicable to the entire device.

In FIG. 2, all the relays are shown in the connected position, in which all the capacitors are interconnected in parallel. If all the relays are connected in series, they provide a maximum voltage of 218.7 volts in the fourth stage. If some are connected in parallel and some are connected in series, various lower voltage values can be obtained.

Alternatively, more than three, i.e. four, five, etc. capacitors or groups can be interconnected in each of the individual stages such that other maximum voltages and voltage steps are achieved. It is also possible to group them differently in the individual stages, i.e. to connect three capacitors in the first stage to form first groups G1 and to then connect five groups G1, G2, etc. in each of the additional stages to form additional groups, for example.

Within each of the groups, the connection type must always be the same, i.e. either in parallel or in series. In addition, the same number of elements must always be provided within the stages, i.e. the same number of capacitors in all first groups G1, the same number of groups G1 in the second group G2 of the second stage, etc., for example.

Above all, the condition that the same number of elements is provided in all the groups within one stage is of major importance in connection with taking defective capacitors out of service, which is yet to be described in the following, and requires the use of special relay arrangements or of 3-pole relays at the second stage. These relay arrangements or variants can optionally also be used at the first stage.

In the first stage, only connecting a few, for example three, capacitors each time to form groups is advantageous in regard to measures required if individual capacitors fail due to defects. If an individual capacitor in one group G1 fails, the group G1 that contains the defective capacitor needs to be switched off in the next stage. In addition, it is mandatory for a group G1 to be taken “offline” in all the other groups G2 and for all the groups G2 to be switched to parallel. How the groups of the other stages, including G1, are connected is irrelevant and is selected by the electronic control system.

The smaller the number of interconnected capacitors in one group, the smaller the probability of a group failing due to a defect of an individual capacitor. The greater the number of elements within the group G2, the lower the percentage of the capacitors taken “offline.”

The relays used to switch between series and parallel are preferably connected such that, in the default position, i.e. therefore without voltage at the armature, the capacitors or groups are connected in series (i.e. as shown in FIG. 1.a)) and are connected in parallel when there is voltage at the armature. This has the advantage that defective capacitors, for example that have become conductive, cause the smallest possible amount of damage to the overall system. When connected in series, the power simply flows through them, increasing the damage to their dielectric but not affecting or barely affecting other capacitors. When connected in parallel, they act on the other capacitors of their group and of the entire device like a short circuit, which would cause considerable destruction. Therefore, the device is deactivated, but not fail-safe. The 3-pole relays, which are yet to be described, are advantageous for achieving fail-safeness and are therefore preferable to use.

The various connection variants, a few of which are mentioned above by way of example, make it possible to provide a plurality of different voltage steps. These become interesting as the total charge decreases, in which a desired output voltage remains available by means of additional series connection of groups.

Capacitors comprise a different discharge curve than batteries. The available voltage is substantially proportional to the stored charge, i.e. a capacitor that still has half its charge has half the voltage available when it is fully charged. However, consumers in everyday life require a uniform that is as constant as possible, or with interposed DC-DC inverters, a voltage bandwidth, which has to be adhered to. Inverters require a “supply”, which lies in a specific bandwidth and typically may not vary by more than a certain factor, often by a factor of three. This renders voltage steps absolutely necessary for practical use, i.e. voltage stages that allow for adaptation, i.e. switching, during operation. The device described here comprises precisely this property. The above-described groups can be connected such that switching can occur at any time, which means that inverters used can be continuously supplied with the voltage they require. An adequate supply voltage can therefore always be provided to the inverters depending on the state of charge and loading of the capacitors in order to supply the consumers with power.

If, for example, a 24-volt motor were to be operated, the capacitors or groups are initially connected in parallel in three stages and in series in one stage, and, as the charge decreases, increasingly more stages are changed from being connected in parallel to connected in series. In this example, there are nine capacitors connected in series at stage 1, as group G1, a voltage of approximately more than 24 volts. G1 therefore contains nine elements. Groups G2, G3 and G4 are therefore intended to each contain three elements or subgroups in this example. This device therefore contains 9×3×3×3=243 capacitors.

If G1 is switched to series and G2, G3 and G4 are switched to parallel, an output voltage of 24.3 volts is available. If the capacitors are then drained to 33% during power consumption and 7.2 volts is therefore applied, by switching just one of the three overlying groups or stages from parallel to series, an output voltage of 24 volts can be re-achieved. Therefore, the device comprises the “parallel” connection type at two stages or in two groups and the “series” connection type in two stages. If, in the event of further discharging, 7.2 volts is achieved once again, all that needs to be done is to switch an additional group or stage from parallel to series in order to be able to provide 24 volts once again, etc.

Of course, the voltage applied when fully charged would be 656.1 volts if all the stages or all the groups were connected in series (243 capacitors at 2.7 volts=656.1 volts). If these are all connected in series and the group reaches a voltage of 7.2 volts, in absolute terms this shows that the capacitors still have a residual charge of 1%. This shows that almost 99% of their capacity has been utilized and there are no losses of capacity as a result of series charging. For this task, groups of five capacitors are the suitable solution in the first stage, since they have fewer but wider voltage steps, which lie closer to the desired target consumer voltage.

According to another embodiment, DC-DC inverters, also called DC-DC step-up converters, are used to amplify or increase the voltage and to be able to constantly offer the same voltage to the consumer. DC-DC inverters have degrees of efficiency of approximately 90%. They can ensure a constant defined output voltage with a variable input voltage and provide a constant defined lower-level output voltage from a higher input voltage. The latter can be used for charging the mobile unit, which involves the following advantages:

Groups of capacitors connected in parallel can be charged in series and thereby do not suffer any loss in terms of their overall capacity, since they are isolated from one another by the DC-DC inverters, which can also be thought to be electron pumps. As a result, the voltage applied to charge cables can be considerably higher, which involves faster charging and fewer transmission losses. Within certain limits, this can be taken further by a higher value that is not 2.5 volts being selected for the input voltage of the DC-DC inverters.

Under load, the voltage that said cells provide decreases proportionally to the power drawn by the consumer. Conversely, the cells have the feature that, if the load discontinues, they “recover”, i.e. that the voltage applied re-increases over time to a higher level than previously under load. Conventional chemical batteries also have this behavior, but to a far lesser extent, which is why this effect is usually disregarded. This effect is slightly more pronounced in pseudocapacitors than in “supercapacitors” or “ultracapacitors.”

Since “voltage steps” can be used, the energy store “adapts” to the consumer. Another advantageous element of the present invention is a 3-pole relay.

A normal changeover relay connects an input terminal in the idle position to one of two working terminals (NC=“normally connected”). If a voltage is applied to the control terminals, the input terminal is connected to the other working terminal (NO=“normally open”).

The 3-pole-1-changeover relay 10 shown in FIG. 3 comprises two working terminals 6, 7 in the same way as the two-pole relay, but neither of which are connected to the input 8 in the idle state, instead this is in a central position (FIG. 3b, fail-safe position). In this position, the input terminal is connected to an additional further output terminal 9 in the center. By applying a positive voltage difference to the control terminals, the input, as shown in FIG. 3a, is connected to the working terminal 6 and is connected to the working terminal 7 when a negative voltage difference is applied, as per FIG. 3c.

Alternatively, the relay can be designed such that only positive opposing voltage differentials can be applied, but these are simultaneously ruled out in a manner controlled by microelectronics; however, if this were to occur nonetheless, the design would be “fail-safe,” since both signals would be cancelled out and the relay would remain in the central position;

In all cases, the contactor will be moved into the central position by two spring elements and held there if no control voltage is applied.

FIG. 3d shows the respective connection types as a circuit diagram.

If the device is designed using components available today or in accordance with the above-described theoretical considerations, it will have the following issues: all relays of one stage should be switched within the same milliseconds, and specifically within the time period in which (FIG. 3) the contactor leaves or breaks the contact with the output terminal 6 by the activation (or deactivation) of the armature or the coil, travels the route to the other output terminal 7 and produces the connection to 7 there. This is a very short timeframe and it is extremely unlikely that all relays in a device carry this out quickly enough, i.e. the last relay interrupts the contact with 6 before the first relay has made the contact with 7, and it may therefore be assumed that, in such an apparatus, huge fault currents occasionally develop during the switching process, even when using a Finder master adapter.”

Only the entire system can be measured and not individual groups or capacitors, since these are constantly interconnected. This is very problematic if components such as relays or capacitors change their properties, as this cannot be detected. Therefore, there is no opportunity to be able to intervene in emergencies if, for example, a capacitor or a relay malfunctions.

When implemented practically, the device therefore has the following features:
a. The time period in which a relay does not make contact with either terminal output (6 or 7 in FIG. 3) can be of any length and can be freely selected,
b. individual capacitors and individual groups G1, G2, etc. can be fully isolated from the rest of the system,
c. faulty components can be taken out of the device, and
d. the device comprises options to intercept and handle emergencies.

This is made possible by the third position of the 3-pole relay, which will be referred to as the central position in the following. To be specific, this means that, when switching from parallel to series, in a first step a switch is made from parallel to the central position until all relays have reached this state, and then only in a second step is a switch made to series. Switching from series to parallel accordingly also happens in two steps, whereby individual capacitors or groups, since being in the central position of the relay, can furthermore be completely isolated from the rest of the system and individually measured, as a result of which faulty components are recognized and it is possible to have the most possible control over the entire system.

Unlike the above-described theoretical considerations with conventional “2-pole relays,” a device that uses 3-pole relays requires two more relays within each group. This follows from the following consideration: in the theoretical consideration set out above, relays are used between capacitors with the primary aim of being able to switch between connection types, but here they are used in front of and behind a capacitor with the primary aim of being able to isolate them from the rest of the system and being able to handle them.

Practical and economic considerations suggest only using 3-pole relays at the second stage, i.e. in the groups G2. This is linked to the following conditions: at the second stage, 3-pole-2-changeover relays can preferably be used; during each switching process at all other stages other than the second stage, the relays of the second stage 2 are first moved into the central position, then the actual switching process takes place and then the second stage is moved back into the previous position; within groups G1 (and also G3, G4, etc.), 2 changeovers (or better still 4 changeovers or for n capacitors n*2 changeovers) have to be used, since unlike individually used 1-changeover relays these always have the same position between the input and output terminals, this being guaranteed by their design (FIG. 1).

Due to these conditions, all groups G1 are isolated from the rest of the system during the switching process, which means that different switching times of the relays do not have any consequences. Therefore, conventional 2-pole-2-changeover relays can be used at all other stages except for the second stage. The entire device is therefore inherently fail-safe.

FIG. 4 shows three capacitors connected by means of 3-pole relays according to the arrangement shown in FIG. 1. Six of such relays are required in order to connect a group G1. FIG. 5 shows three groups G1 connected by means of six additional 3-pole relays to form a group G2 according to the arrangement shown in FIG. 2a. Groups in additional stages are connected in the same way as in the embodiment described first of all.

If such a 3-pole relay is used within the context of the present invention, in the idle position the input terminal is connected to an additional further output terminal, which can be used within one group G1 in order to measure individual capacitors and to leave out a defective capacitor, and can be used between the groups G1 for connection to the charging station (s, i.e. DC-DC converters).

The additional central position can therefore be used to measure an individual capacitor with regard to its state of charge, charge acceptance that has occurred (i.e. whether it actually also stores what it should), and other individual values, such as internal resistance, capacity or the capacity that is actually afforded, and therefore stage of the ageing process, or to optionally mark it as out of service, or to take the entire group offline in emergencies (caused by material errors or fatigue), such as short-circuit behavior. In addition, in the central position, individual groups can be charged, measured or characterized as (virtually or actually) out of service independently of the other groups.

The central position also makes it possible to charge the groups individually, i.e. decoupled from one another, which requires parallel charging and additionally speeds up the charging process.

FIG. 4 shows three capacitors connected by means of 3-pole relays according to the arrangement shown in FIG. 1. Six of these relays are required in order to connect a group G1.

FIG. 5 shows three groups G1 connected by means of six additional 3-pole relays to form a group G2 according to the arrangement shown in FIG. 2a. The groups are connected in additional stages in the same way as in the embodiment described first of all.

For optimum use within the context of the present invention, six of these 3-pole-1-changeover relays or one 3-pole-6-changeover relay is/are integrated in a third group in each case. By means of the latter, a group consisting of three capacitors can be switched between series and parallel by means of a single 3-pole-6-exchanger relay. Such a group G1 comprises three connecting cables, specifically a positive and negative cable of the capacitor group (0 to 2.5 V parallel, 0 to 7.5 V series), a relay supply cable (12 V) and a control cable for the relay (−5, 0 or 5 volts). 2-pole-4-changeover relays are usually standard; therefore, 3-pole-4-changeover relays should be easy to implement.

The charging process can be done by means of conventional power sources, i.e. by means of charging equipment that provides the required charging voltage of 2.5 volts, for example. Alternatively, charging can be done using the method and the device described in the parallel patent application CH . . . , to the content of which reference is hereby expressly made. This way of charging by means of capacitors is considerably more efficient, saves considerably more energy and is therefore considerably more environmentally friendly, since no control equipment that heats up has to or may be used. In addition, it is substantially quicker when optimally adjusted.

In a group G2 of the second stage, each group G1 obtains its own relay in order to be charged or not charged, the latter in the event of a fault, i.e. if a capacitor is defective and the relevant group is taken “offline.” In a G1 group, all capacitors are connected in parallel and ready to be measured or charged.

If a G1 group has been gauged as working by the microchip, the charging control relay is activated and it can be charged, otherwise it remains open.

In a G2 group of the second stage, all G1 groups are combined, and therefore the entire device, for example in the case of three G3 groups each consisting of three G2 groups, has a total of 9 units to be charged. If there are additional stages, said groups are combined on the stage below the top stage in each case.

These G2 groups can be charged by charging equipment or capacitors. In the first case, the charging cable to the charging station contains two cores and has its own connection socket to the vehicle. In the second case, it comprises nine two-core cables, a data line and likewise its own connection socket. Which variant comes into play is determined by the type of charging station used.

If a charging station offers alternating current, a rectifier, possibly including a voltage converter, is connected between the charging cable and the DC-DC converters in order to comply with the specifications.

If it is a capacitor charging station, each G2 group is directly and constantly connected to a charging control unit (CCU) in the charging station.

In the first step, the controller of the device informs the charging station of how large the capacity of the capacitors is (if they are all identical), how many capacitors are online in which G2 groups (if all are connected in parallel) and to which of the nine lines these are connected.

The charging station thus has all the necessary information, except if in the future capacitors with a higher maximum allowable voltage were to come into the market; this information would then also have to be communicated.

In the second step, the charging station measures the voltages applied to the nine lines in each case. If these differ from one another too greatly, a troubleshooting routine is activated, otherwise charging is initiated.

By means of the data obtained, the CCU then selects the “ideal” capacitors and connects each of them to the charging cable. If a charging capacitor is empty, i.e. has carried out its task, it is removed from the charging cable, the next charging capacitor is dialed and connected to the charging cable.

For this purpose, the CCU requires a solid relay that switches high currents and a group of, for example, four rotary dials as were used in old telephone systems in order to be able to exclusively operate 36 capacitors in each case (one dialing unit has ten terminals; one capacitor leads to nine, the tenth is empty, “not connected”).

Therefore, the CCU can now charge the G1 group in the vehicle in 3% steps.

Depending on the capacity of the capacitors installed in the vehicle, above a certain charge thereof, for example 80%, and since the physical maximum capacity of individual charging capacitors has been achieved, “equivalent” charging capacitors may be used, which in turn consist of a plurality of charging capacitors.

If a charging station is intended to charge vehicles using capacitors having different capacities, it is necessary for the CCU to comprise correspondingly more rotary dials and charging capacitors connected thereto (having different capacities).

The negative terminals of the charging capacitors are directly interconnected. They are charged in series using Zener diodes, in parallel or via rotary dials.

Charging of the mobile capacitors by means of stationary capacitors is very quick and has a very high degree of efficiency.

1. A method for utilizing the capacity of mobile capacitors, characterized in that the mobile capacitors are connected in parallel in order to charge and are connected in series in order to output current, and the capacitors are grouped in several stages such that, in a first stage, groups consisting of a plurality of interconnected capacitors are formed, in a second stage, a plurality of groups from the first stage are, in turn, interconnected to form additional groups, and, in further stages, groups of each of the preceding stages are interconnected to form additional groups in each case.

2. The method as per claim 1, characterized in that the groups each consist of three interconnected capacitors or groups.

3. A system for carrying out the method as per claim 1 of charging mobile capacitors as per claim 1, characterized by a plurality of capacitors interconnected to form groups and a connection device for alternately connecting the capacitors in series or in parallel.

4. The system as per claim 3, characterized in that a plurality of groups are interconnected in stages in each case.

5. The system as per claim 4, characterized by relays for connecting the capacitors and groups.

6. The system as per claim 5, characterized in that the relays are 3-pole relays.
